(19) United States
(12) Patent Application Publication
(10) Pub. No.: US 2023/0117069 A1
(43) Pub. Date: Apr. 20, 2023

(54) METHOD AND APPARATUS FOR GENERATING HYDROGEN GAS AND ELECTRICITY FROM RECYCLED METAL

(71) Applicants: Sudithi MANTHATI, SUNNYVALE, CA (US); Rishita SHAH, CUPERTINO, CA (US); Anagha BADRIPRASAD, CUPERTINO, CA (US); Sonia SWAMY, CUPERTINO, CA (US); Suresh MANTHATI, SUNNYVALE, CA (US); Rajesh Kantilal SHAH, CUPERTINO, CA (US)

(72) Inventors: Sudithi MANTHATI, SUNNYVALE, CA (US); Rishita SHAH, CUPERTINO, CA (US); Anagha BADRIPRASAD, CUPERTINO, CA (US); Sonia SWAMY, CUPERTINO, CA (US); Suresh MANTHATI, SUNNYVALE, CA (US); Rajesh Kantilal SHAH, CUPERTINO, CA (US)

(21) Appl. No.: 17/910,747

(22) PCT Filed: Mar. 24, 2021
(86) PCT No.: PCT/US2021/023885

§ 371 Date: Sep. 9, 2022

Related U.S. Application Data
(60) Provisional application No. 63/001,326, filed on Mar. 28, 2020.

(51) Int. Cl. C01B 3/04; H01M 16/00; H01M 8/0606; C01F 7/04

(52) U.S. Cl. CPC C01B 3/042; H01M 16/00; H01M 8/0606; C01F 7/04

(57) ABSTRACT

Disclosed is an apparatus and method for generating hydrogen from water and recycled soft metals (e.g., used empty aluminum beverage cans). The generated hydrogen can be used as an energy source, for example to power hydrogen fuel cell powered automobiles or to generate electricity for an electrical power grid. The apparatus has a size and weight allowing it to be used where the recycled metal cans are generated, and is suitable for use as a home appliance.

### CROSS-REFERENCE TO RELATED APPLICATIONS

This application claims the benefit of U.S. Patent Application Ser. No. 63/001,326 filed Mar. 28, 2020, entitled, “System and Apparatus to create, store and distribute hydrogen from soft metals using a chemical reaction and local conversion to electricity” and is a national stage application of Application No. PCT/US2021/023885, filed Mar. 24, 2021, entitled “APPARATUS FOR GENERATING HYDROGEN GAS AND ELECTRICITY FROM RECYCLED METAL,” which applications are incorporated herein in their entirety.

### BACKGROUND

### Field

The present disclosure relates generally to generating energy, and more specifically to methods and apparatuses for generating hydrogen gas and electricity from recycled metal.

### Background

In the United States an average of 123,000 aluminum cans are recycled every minute, which comprises only 65% of the aluminum cans in use. As recycling becomes more prominent, the process is becoming more expensive in terms of energy and human resources. Several recycling programs across the US are collapsing, due to the increased cost and energy requirements to transport, sort, and process the recyclable material. The end user also has limited or no control over how the recycled material is processed.

On the other hand, the existing green energy solutions such as solar-, wind-, and water-generated power, are increasing in popularity, but have deficiencies such as dependence on weather and location as well as dependence on batteries for energy storage. Fossil fuel-based energy generation, on the other hand, is not green, is resource-limited, and has a hydrocarbon emission problem which is has been blamed for the gradual warming of the Earth's temperature and the increasing severity of the Earth's climate.

### SUMMARY

Disclosed herein is a method of generating hydrogen using waste or recycled metal food and/or drink containers. The method comprises gathering the metal food and/or drink containers, emptied of food and/or drink; reacting the metal containers with water to produce hydrogen and a metal hydroxide; and collecting the generated hydrogen; wherein the gathering, reacting and collecting steps all occur at a location that is substantially where the food and/or drink is consumed.

A method in accordance with an aspect of the present disclosure comprises combining a metal food container with a fluid in a reaction chamber, producing hydrogen and a metal hydroxide in the reaction chamber, and collecting the produced hydrogen; wherein the producing and collecting occur proximate a point of consumption of food packaged in the metal food container.

Such a method further optionally includes splitting the metal food container into a plurality of pieces prior to combining the metal food container with the fluid in the reaction chamber, wherein a size of the plurality of pieces of the metal food container comprises an average volume of less than 100 mm3 and/or an average weight of less than about 1 g.

Such a method further optionally includes the metal food container being powderized prior to combining the metal food container with the fluid in the reaction chamber, collecting the metal hydroxide, pressurizing the collected produced hydrogen, collecting heat generated at the reaction chamber, producing electricity from the collected produced hydrogen, the metal food container comprises at least one of aluminum, tin-plated steel, an aluminum alloy, and a tin-plated steel alloy, and the metal food container comprising aluminum, the reaction comprising 2Al+6H2O→2Al(OH)3+3H2, and the metal hydroxide being aluminum hydroxide.

An apparatus for generating hydrogen in accordance with an aspect of the present disclosure comprises an inlet for receiving at least one metal container, a water inlet, a reaction chamber, coupled to the inlet and the water inlet, the reaction chamber having at least a hydrogen outlet and a by-product outlet, and a collection chamber for receiving hydrogen from the reaction chamber through the hydrogen outlet, wherein the apparatus comprises a size and a weight such that the apparatus is installable at a location proximate a point of consumption of food packaged in the at least one metal food container.

Such an apparatus further optionally included a grinder, coupled between the inlet and the reaction chamber, for separating the at least at least one metal container into a plurality of pieces, each piece in the plurality of pieces having an average volume of less than 100 mm3, the grinder powderizing the at least one metal container, a by-product collection chamber coupled to the by-product outlet of the reaction chamber for conveying the metal hydroxide out of the reaction chamber, and means for pressurizing the collected hydrogen.

Such an apparatus further optionally includes the apparatus being configured to process at least one of aluminum, tin-plated steel, an aluminum alloy, and a tin-plated steel alloy, a heat exchanger, coupled to the reaction chamber, for gathering heat generated in the reaction chamber, and the apparatus having a size of less than 5 m3.

An apparatus for generating electricity in accordance with another aspect of the present disclosure comprises a plurality of collector apparatuses, each collector apparatus in the plurality of collector apparatuses comprising an inlet for receiving at least one metal container, a reaction chamber, coupled to the inlet, the reaction chamber having at least a hydrogen outlet and a by-product outlet and a collection chamber for receiving hydrogen from the reaction chamber through the hydrogen outlet; a conveying pipeline for coupling the hydrogen outlets from the plurality of collector apparatuses to a centralized collector; and a cell, coupled to the centralized collector and adapted to convert the hydrogen in the centralized collector into electricity.

It will be understood that other aspects of the present disclosure will become readily apparent to those skilled in the art from the following detailed description, wherein it is shown and described only several embodiments by way of illustration. As will be appreciated by those skilled in the art, the principles of the disclosure can be realized with other embodiments without departing from the scope of the present disclosure. Accordingly, the drawings and detailed description are to be regarded as illustrative in nature and not as restrictive.

In one embodiment, the method includes reducing the size of the metal containers by cutting and/or grinding the containers into pieces before reacting with water.

Also disclosed herein is an apparatus for generating hydrogen from water and waste or recycled metal food and/or drink containers. The apparatus comprises a metal container inlet for inserting the metal containers; a reaction chamber, in communication with the metal container inlet and having a water inlet, a hydrogen outlet and a byproduct outlet, the reaction chamber being capable of accommodating a chemical reaction of water, introduced via the water inlet, and the metal pieces, introduced via the metal container inlet, to produce hydrogen and a metal hydroxide by-product; and a hydrogen collecting means for conveying the generated hydrogen out of the reaction chamber into a hydrogen collection chamber; wherein the apparatus has a size and weight that is sufficiently compact to allow use of the apparatus at a location that is substantially the same as where the food and/or drink packaged in the metal containers is consumed.

In one embodiment, the apparatus includes a metal cutter and/or grinder, in communication with the metal container inlet, for cutting and/or grinding the metal containers into pieces and introducing the pieces into the reaction chamber.

Also disclosed herein is a method of generating electricity, comprising placing a plurality of said apparatuses in a region, connecting a hydrogen output from each of said apparatuses to a hydrogen conveying pipeline, conveying hydrogen through the pipeline to a fuel cell and reacting the hydrogen in the fuel cell to produce electricity.

### BRIEF DESCRIPTION OF THE DRAWINGS

Various aspects of the present disclosure will now be presented in the detailed description by way of example, and not by way of limitation, in the accompanying drawings, wherein:

FIG. 1 is a side view, shown partly in phantom, of the apparatus for converting water and recycled metal into hydrogen gas;

FIG. 2 is a side view, shown partly in phantom, of the apparatus for generating hydrogen with a portion showing schematically of how the hydrogen can be conveyed from the apparatus, stored and converted to electrical power;

FIG. 3 is a schematic flowchart showing how the apparatus processes metal, generates and stores hydrogen, and generates electricity using a fuel cell;

FIG. 4A is a side view of an apparatus, shown partly in phantom, showing how the input of metal to be processed for hydrogen generation can be configured;

FIG. 4B is a schematic diagram showing how the portion of the apparatus shown in FIG. 4A operates and is controlled;

FIG. 5A is a side view of an apparatus, shown partly in phantom, showing how hydrogen is generated by the apparatus and the systems used to control hydrogen generation;

FIG. 5B is a schematic diagram showing how the portion of the apparatus shown in FIG. 5A operates and is controlled;

FIG. 6A Is a side view of an apparatus, shown partly in phantom, showing how the hydrogen generated by the apparatus can be stored and used;

FIG. 6B is a schematic diagram showing how the portion of the apparatus shown in FIG. 6A operates and is controlled;

FIG. 7 is a schematic view, similar to FIG. 2, showing the transmission of hydrogen generated from a plurality of apparatuses of the type disclosed herein to a centralized hydrogen storage facility and used to power a fuel cell;

FIG. 8. is a schematic diagram showing one configuration of using multiple apparatuses of the type disclosed herein with centralized hydrogen storage, using the hydrogen to power multiple fuel cells to generate electricity, and transmitting the generated electricity to an electrical power grid for community use; and

FIG. 9 is a flow diagram illustrating a method in accordance with an aspect of the present disclosure.

### DETAILED DESCRIPTION

The detailed description set forth below in connection with the drawings is intended to provide a description of exemplary embodiments, and it is not intended to represent the only embodiments in which the disclosure may be practiced. The term “exemplary” used throughout this disclosure means “serving as an example, instance, or illustration,” and should not necessarily be construed as preferred or advantageous. The detailed description includes specific details for the purpose of providing a thorough and complete disclosure that fully conveys the scope of the disclosure to those skilled in the art. However, the disclosure may be practiced without these specific details. In some instances, well-known structures and components may be shown in block diagram form, or omitted entirely, in order to avoid obscuring the various concepts presented throughout this disclosure.

The method and apparatus disclosed herein permit hydrogen to be generated at a location that is very close to the consumption of food and drink that is packaged in metal containers, so that the emptied metal food and drink containers can be recycled and converted into hydrogen, as an energy source, at the very location where the food is consumed and the waste or recyclable metal containers are generated. For example, the apparatus for generating hydrogen gas disclosed herein is compact and lightweight enough to be used in a residence, e.g., in a garage of a single-family residence. In such a case, the metal container waste that is generated by the home's residents can simply be recycled in the garage to produce hydrogen. In another example, the apparatus for generating hydrogen gas disclosed herein can be used in a school or corporate cafeteria, or in a kitchen therefor. In such cases, the metal container waste that is generated by the patrons of the cafeteria can simply be recycled in the cafeteria kitchen or any adjacent spaces to produce hydrogen. Such close (e.g., no more than 200 meters apart and in certain embodiments no more that several meters apart) point of consumption and point of hydrogen generation is also referred to herein as edge recycling and is an important benefit of the present apparatus and method since the need to collect and convey (e.g., by truck) recycled metals to a central storage and/or processing plant is thereby obviated.

While an apparatus according to the present disclosure can operate as a single, stand-alone unit, generating hydrogen and/or electrical power for only the owner or renter of the unit, the present disclosure also contemplates combining the hydrogen generating outputs of a plurality of such units, and conveying the hydrogen output of multiple units through one or more hydrogen conveying means, e.g., pipelines, to a centralized location where the hydrogen can be stored in larger quantities and/or converted to electricity in larger quantities.

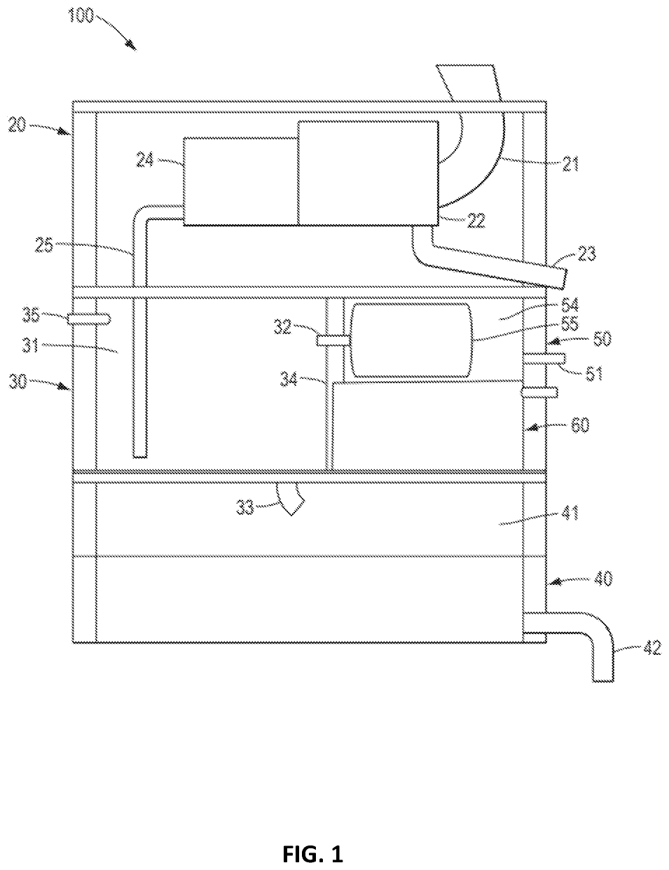

Referring now to the figures and the apparatuses disclosed therein, FIG. 1 shows one embodiment of a hydrogen generating apparatus 100 and its component parts. Apparatus 100 is shown with a roughly cylindrical shape and having an outer double wall construction typically made of metal. Apparatus 100 comprises a recycled metal input assembly 20, a reactor assembly 30, a by-product collection assembly 40, a hydrogen gas collection assembly 50 and a heat exchange assembly 60. The vertical arrangement of assembly 20 being positioned above reactor assembly 30 and gas collection assembly 50, which in turn are positioned above by-product collection assembly 40, allows the apparatus 100 to operate using gravity to direct the flow of solid and liquid materials, for example the recycled metal containers, the water used in the reaction chamber 31, and the by-product metal hydroxide of the chemical reaction occurring in chamber 31, to the next stage of processing without requiring the use of pumps, conveyors and the like, which is advantageous from a cost and a simplicity of design perspectives.

The recycled metal input assembly 20 includes an input chute 21. Optionally, the metal input assembly 20 includes a metal cutting-grinding assembly 24 for reducing the size of the recycled metal pieces (e.g., aluminum drink cans) into small pieces such as metal shards or particles and an outlet pipe 25 for introducing the metal shards and/or particles into the reaction tank 31. Optionally, the metal input assembly 20 also includes a sorter 22 which sorts the introduced recycled metal objects into acceptable ones that are fed into the cutting-grinding assembly 24 and unacceptable ones (e.g., non-metallic materials, or in the case of an apparatus 100 that is designed only to process aluminum metal, then non-aluminum materials) ones. The sorter can operate via magnets in order to separate aluminum metals from iron-based metals, or other means such as NIR (near infrared) sensors, hardness sensors and/or other indicators which can distinguish between metallic and non-metallic materials. The introduced objects that are rejected by sorter 22 can then be discarded via material reject chute 23.

In another embodiment, apparatus 100 has no sorter 22 or reject chute 23 and simply relies on the user to introduce the correct materials into chute 21 for direct introduction into apparatus 100. Such a design is less complex and less expensive to make and yet is still workable from the standpoint of a unit designed to be operated within a user's residence (e.g., a garage).

The reactor assembly 30 has a water inlet 35, typically in the form of a valved pipe, which is used to introduce water and optionally a reaction promoter or catalyst, such as aluminum oxide and/or a pH raising material such as lye or sodium hydroxide, into the reaction chamber 31. Chamber 31 also has an outlet 32, which has a one-way valve, through wall 34 separating chamber 31 from hydrogen collection chamber 54. Valved outlet 32 allows hydrogen gas produced within chamber 31 by the reaction of water with metal (e.g., aluminum) to be conveyed into collection chamber 54.

A heat exchange assembly 60 is also provided and is in heat transmitting contact with wall 34. Since the reaction of water with metal to produce hydrogen gas is exothermic, the reaction mixture within chamber 31, and wall 34, will become heated. The heat exchange assembly 60 harnesses at least a portion of the heat generated in the exothermic reaction to compress the hydrogen gas after it is conveyed into chamber 54 as is described in greater detail hereinafter.

In one embodiment, the hydrogen gas transferred through valved outlet 32 is fed into a compressor 55 which compresses the hydrogen prior to release into the chamber 55. Different types of compressors can be deployed such as reciprocating, rotary, centrifugal or metal hydride compressors. The compressor 55 facilitates the flow of the hydrogen gas generated in the reaction chamber 31 by maintaining a lower pressure on the reaction chamber 31 side, and higher pressure on the collection chamber 54 side, of wall 34.

In certain embodiments, the apparatus 100 uses the heat generated by the exothermic water-metal reaction in chamber 31 to be used by the compressor 55. One mechanism for doing this is a metal hydride compressor. A metal hydride compressor is a hydrogen compressor based on metal hydrides with absorption of hydrogen at low pressure, releasing heat, and desorption of hydrogen at high pressure, absorbing heat, by raising the temperature with an external heat source such as the heated coils of the heat exchange assembly 60. The advantages of using a metal hydride type compressor are the high volumetric density, no moving parts, simplicity in design and operation, the possibility to consume waste heat from the exothermic water-metal reaction instead of electricity and reversible absorption/desorption.

The lower wall of chamber 31 is provided with a valved outlet 33 which allows spent reaction materials, and any by-products of the water-metal reaction, to be collected in collection tank 41 and collected via pipe 42. In the case of aluminum being the primary metal used in this reaction (2Al+6H2O→3H2+2Al(OH)3), the primary byproduct is aluminum hydroxide which can be collected, dried and used as a fire retardant for plastics and in pharmaceutical applications such as antacid.

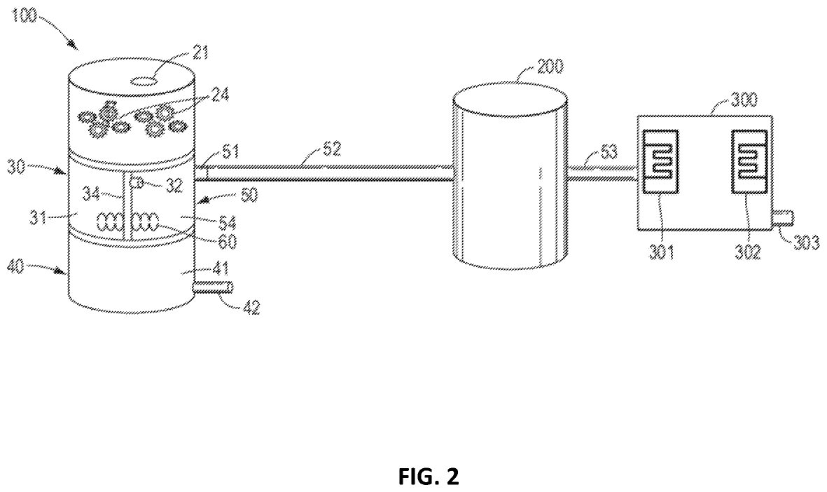

In use, recycled metal food and/or drink containers, such as empty aluminum beverage cans, are introduced into chute 21, accepted by the sorter 22 if present, introduced into the metal cutting-grinding assembly 24 if present, where the metal is reduced to shredded or powdered form. When a sufficient amount of metal has been collected, the metal is then introduced into the reaction chamber 31 together with water introduced through valved inlet 35. The amounts of metal and water introduced into chamber 31, as well as any optional reaction promoters such as aluminum oxide and pH increasing materials such as lye or sodium hydroxide, can be performed automatically via computerized controls, including pumping oxygen and other atmospheric gases out of the chamber 31 since these gases are needed to conduct the metal-water reaction. Once the correct amounts of metal and water are introduced into chamber 31, the reaction begins, and in the process generates hydrogen gas. The hydrogen gas that is generated is bled off into chamber 54 through one-way valved outlet 32. As the reaction in chamber 31 proceeds, the temperature of the reaction mixture (metal, optionally powdered or shredded, and water) begins to rise due to the exothermic nature of this reaction. The heat exchange assembly 60 collects some of this generated heat which can be used as an energy source for some of the downstream hydrogen pressurizing and conveying steps described later herein. Once the reaction in chamber 31 has reached completion, or at least near completion where very little hydrogen is being generated, the remaining reaction mixture can be removed from chamber 31 via outlet 33 into by-product collection tank 41. Outlet 33 is valved closed during the metal-water reaction. The hydrogen generated in chamber 31 and conveyed into chamber 54 can then be transferred to a more acceptable, e.g., larger capacity, hydrogen storage container by conveying the hydrogen from chamber 54 through valved outlet 51 via appropriate hydrogen conveying means such as gas conveying pumps and pipe 52 as shown in FIG. 2 to a larger hydrogen storage container 200.

The apparatus accepts soft metal in many forms, including metal cans commonly used to package food and drink. Such food and drink cans are most typically comprised of aluminum, tin-plated steel, an alloy of aluminum and/or an alloy of steel that is tin-plated. The apparatus 100 is designed to accommodate metal food and drink containers made of those materials, or a mix of different types of containers, e.g., some made of aluminum and some made of tin-plated steel. In other embodiments, the apparatus 100 can be designed and operated to accept only one type of metal food and/or drink container, for example only those substantially comprised of aluminum. Such a design is simpler from the standpoint of by-products generated in the chemical reaction of the metal with water since with substantially only one kind of metal (e.g., aluminum) being introduced into the reaction chamber 31, only one type of metal hydroxide, namely aluminum hydroxide, is produced by the reaction and thus no sorting out of a single metal hydroxide from a mix of metal hydroxides in the by-product stream is needed.

While whole metal food and/or drink containers can be introduced directly into the reaction chamber 31 without any cutting or grinding, the rate of the hydrogen generating reaction is lowered as the size of the metal pieces increases. For purposes of increasing the rate of hydrogen generation via the metal and water reaction, in certain embodiments the apparatus 100 prepares the recycled metal containers for the chemical reaction by cutting, shredding and/or grinding the metal into small pieces. In one embodiment, the metal pieces have an average volume of less than about 100 mm³ and/or an average weight of less than about 1 g. In another embodiment, the metal pieces have an average volume of less than about 20 mm³ and/or an average weight of less than about 0.2 g. In another embodiment, the metal pieces are in the form of a metal powder. The term “powder”, means that the recycled metal containers are reduced to particle form, for example, particles produced by the grinding, crushing, or other disintegration of the metal containers. In yet another embodiment, the metal powder has an average particle size of about 100 μm to about 1 mm.

In certain embodiments the metal food and/or drink containers are rinsed off and/or cleaned of leftover food and drink prior to introduction into apparatus 100. Although not shown in the FIG. 1, in one embodiment the apparatus 100 has a metal container rinsing or washing assembly. Such an assembly, essentially a small dishwashing unit, can be positioned between the input chute 21 and the cutting-grinding assembly 24. In another embodiment, the apparatus 100 may contain an assembly for removing any surface coatings that are typically found on metal food and drink containers, for example interior coatings such epoxy resins (e.g., BPA-based resins), acrylic, polyester and polyolefin surface coatings, and exterior coatings such as inks, paints and varnishes. Most of these coatings are organic in nature and can be oxidized and removed through the use of heat. Thus in one embodiment, the apparatus 100 also includes an assembly for heating the metal food and drink containers, or for heating the metal pieces after they have been though a cutting and/or grinding process, to a high enough temperature, e.g., greater than 300° F., to burn off the organic coating(s). Such a pre-reaction treatment step ensures that less impurities are introduced into the reaction chamber 31 and later into the by-product collection tank 41.

Although not shown in FIG. 1, the apparatus 100 can have a plurality of reaction chambers 31, allowing sequential use and hydrogen generation from multiple reaction chambers 31 and conveyance into hydrogen collection chamber 54. This also allows for one chamber 31 to be drained and/or cleaned while another chamber 31 is continuing to react metal and water and generating hydrogen.

In order for the apparatus 100 to be used at a location that is very close to the location where the recyclable metal food and/or drink containers are initially generated, i.e., at or very near the location where the food and/or drink within those containers is consumed, it is important that the size of the apparatus be small enough to be placed at such an edge location where the food and drink is actually being consumed. The apparatus 100 is sufficiently compact to be used at such edge locations, including in a single-family home (e.g., in a garage for such a home) or in or near a cafeteria or a restaurant kitchen. To accommodate such edge location placements, the apparatus 100 typically has a size of less than about 5 m³, and in some embodiments a size of about 0.3 to about 4 m³. The size and weight of the apparatus 100 varies depending on its features and whether or not certain optional features are present. For example, including one or more of a sorter 22, a metal cutting-grinding assembly 24, a means for rinsing or cleaning the metal containers, and a means for removing any surface coating(s) from the metal containers all increase the size and weight of apparatus 100. However, simpler designs of apparatus 100 that rely of the user to prewash the metal containers, and do the appropriate sorting eliminates the need for some of these additional features making the overall apparatus smaller and more light-weight. In one embodiment, the apparatus 100 has the approximate size and weight of a typical residential refrigerator or stand-alone freezer.

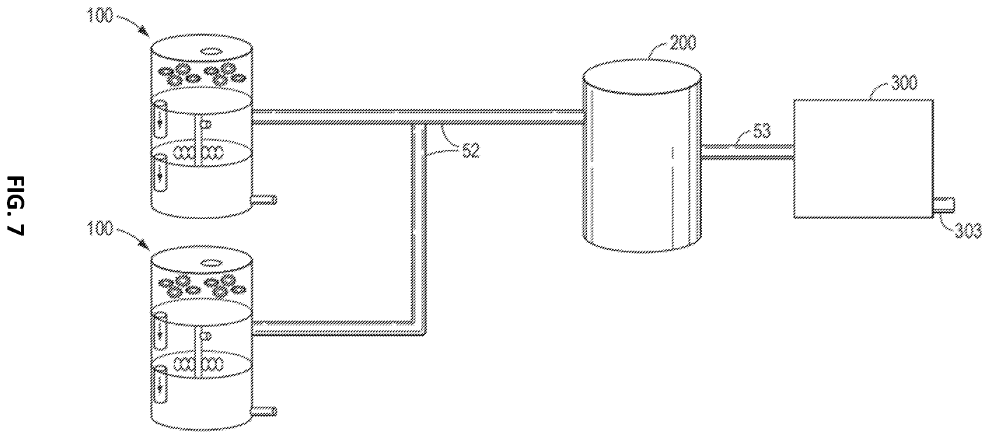

FIG. 2 is a side perspective view of apparatus 100 connected to an external hydrogen storage container 200 and means for conveying the stored hydrogen to a fuel cell 300. Apparatus 100 is shown with metal cutting-grinding assembly 24 shown conceptually as a series of cutting and grinding wheels. The hydrogen gas that is collected in chamber 54 is released by opening valved outlet 51 and conveyed through pipe 52 into hydrogen storage container 200. Storage container 200 can take the form of a pressurized tank so that the hydrogen is stored and kept in liquid form. Although not shown in the figures, those skilled in the art will appreciate that means for conveying and pressurizing the hydrogen gas to move it from the relatively low-pressure environment of chamber 54 into a relatively high-pressure container 200 requires equipment such as pumps, piping and specialized valves of the type that are well known for making such conveyances. Once stored in the container 200, the hydrogen can be released via pipe 53 as needed into either a smaller container, such as the pressurized fuel tank of a hydrogen-powered automobile, or directly into a fuel cell 300 comprised of a pair of electrodes 301, 302, typically separated by a membrane (not shown) for generating electrical power. The fuel cell 300 does not generate carbon dioxide during the consumption of hydrogen, the only by-product is water, which can simply be released to the environment via drain 303. Those skilled in the art will appreciate that a plurality of apparatuses 100 can be deployed and linked together in order to supply hydrogen to a storage container 200 and/or to a fuel cell 300, as shown in FIG. 7.

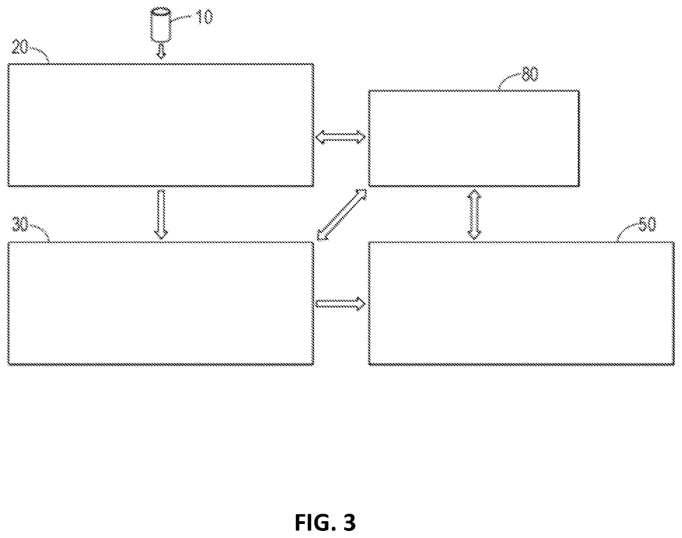

FIG. 3 is a schematic diagram showing how recycled metal is processed through the apparatus 100. The single headed arrows represent the flow of material through the apparatus 100 starting from the inputted recycled metal, represented by metal can 10, passing through the input assembly 20 where it is processed, to the reactor assembly 30 where the chemical reaction between aluminum and water generates hydrogen and aluminum hydroxide by-product. The hydrogen is collected in the hydrogen collecting assembly 50 for storage and from there optionally conveyed to an external hydrogen storage container 200 and or to a fuel cell 300 (not shown in FIG. 3) for electric power generation. The operation of assemblies 20, 30 and 50 are controlled by controller 80 which is typically a computerized controller that senses conditions in these assemblies based on sensors placed in the assemblies which feed information back to the controller 80. Based on the sensed conditions, including the amount of recycled metal that has been inputted into the assembly 20, the amount of water inputted, and optionally reaction promoters and catalysts such as aluminum oxide and sodium hydroxide introduced into the reactor assembly 30, the temperature of the reaction mixture in reaction chamber 31, the pressure generated by the hydrogen gas in reaction chamber 31, the operation of heat exchange assembly 60, the opening and closing of the valve in outlet 32 between the reaction chamber 31 and the collection chamber 54, as well as other valves that control the flow of hydrogen out of collection chamber 54 and the flow of chemical reaction by-product into collection tank 41 are all controlled, monitored, and orchestrated by controller 80 as shown schematically by the double headed arrows in FIG. 3.

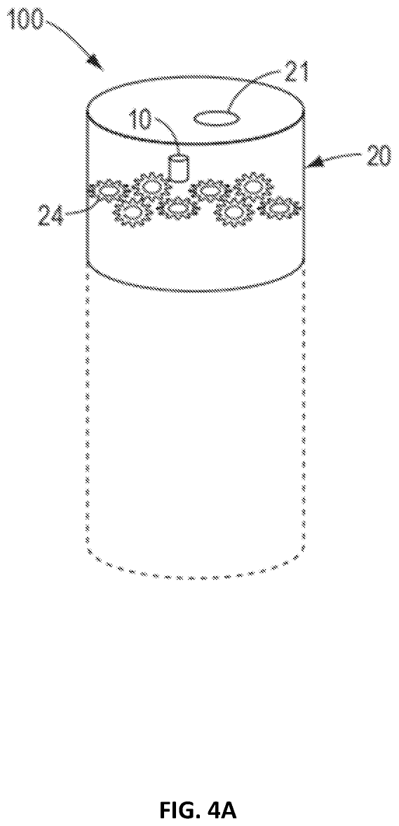

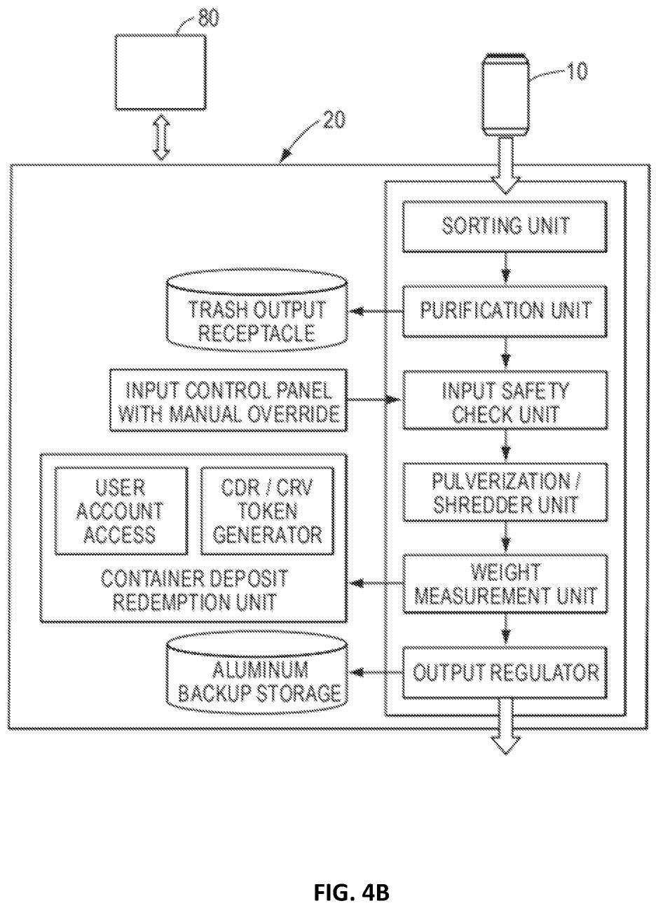

The operation of the assemblies 20, 30 and 50 will now be described in more detail starting with input assembly 20. Referring to FIG. 4, recycled metal, such as metal cans, are collected and inputted into apparatus 100 through input chute 21. The inputted recycled metal optionally undergoes sorting in the optional sorter 22 (not shown in FIG. 4). The sorter, when present, sorts the desired metal input from undesired material and removes the undesired material. Sensors deployed within the sorter 22 and controlled by controller 80 through electrical connections with input assembly 20 identifies the desired metal input and sends it to metal cutting-grinding assembly 24 for further processing while the nonmetals or trash are rejected and sorted out for appropriate disposal. An input safety check unit ensures the input metal from the purification unit is safe for shredding and sends it through the optional pulverization/shredder unit which includes metal cutting-grinding assembly 24. If the sensors detect any unusual metals or objects, the data is relayed to the input control panel as shown in FIG. 4 with a manual override unit to safely shut down the apparatus 100, for complete and through manual inspection. The metal cans are then passed through the pulverization/shredder unit to be shredded and/or ground to increase the surface area of the metal and increase the rate of the chemical reaction process. The weight measurement unit measures the weight of the input metal to provide the users with the container redemption through the container deposit redemption unit. Excess metal is stored in the metal container backup storage unit which is used for later and/or on an as needed basis by the downstream chemical reactor assembly 30 which includes the reaction chamber 31.

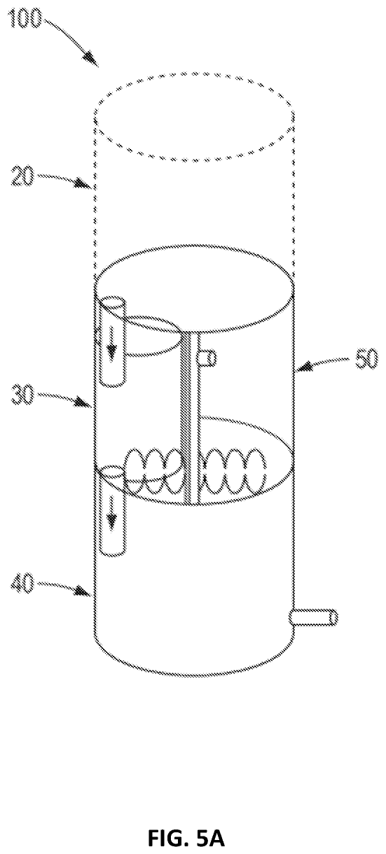

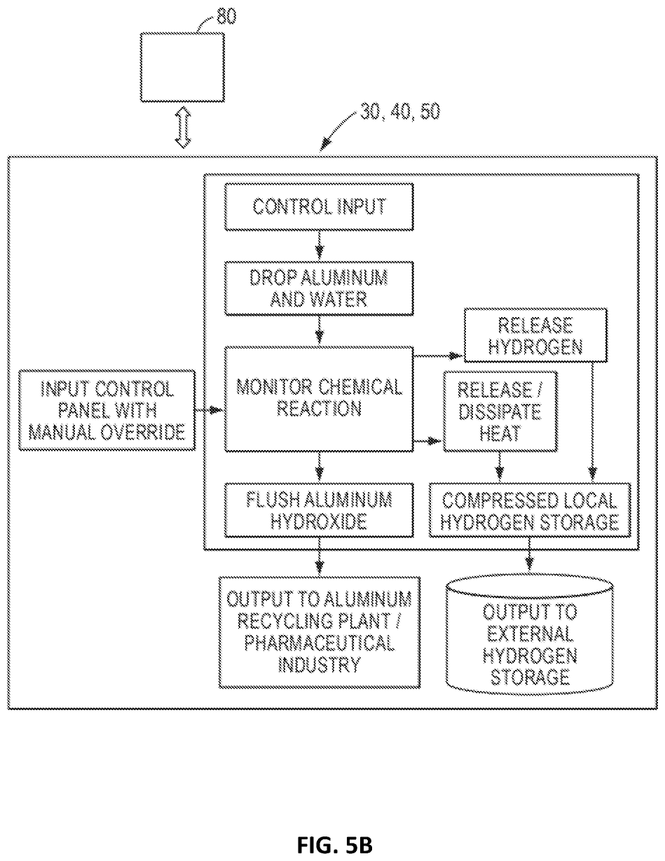

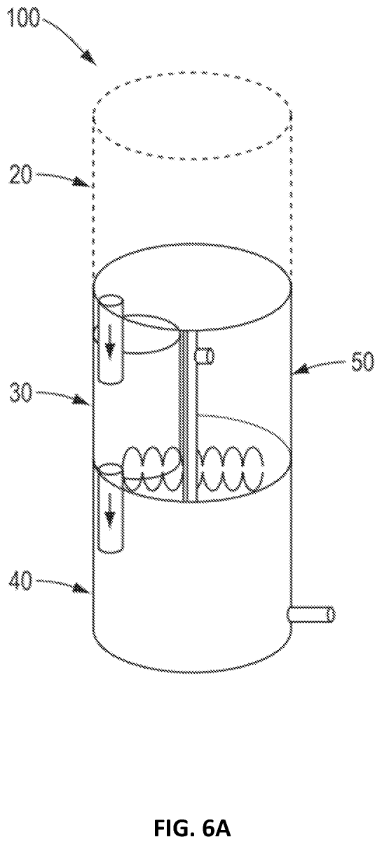

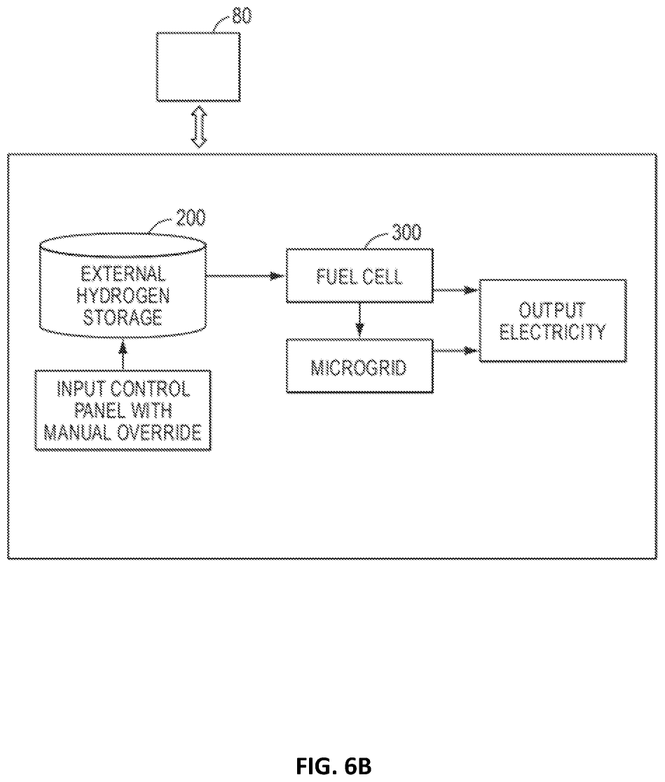

Referring now to FIGS. 5 and 6, the central section of apparatus 100 is comprised of a chemical reactor assembly 30 and a hydrogen collection assembly 50. The component diagram flow of material in the schematic diagram of FIG. 5. The reactor chamber 31 of assembly 30 receives the input metal, in some embodiments in a powdered form, from the output pipe 25 of the assembly 20. The shredded and/or pulverized metal increases the surface area and speeds up the reaction process. The quantity of the shredded/pulverized metal along with an appropriate quantity of water, and optionally a reaction promoter such as aluminum oxide and/or a pH increasing agent such as lye or sodium hydroxide, is released into the reaction chamber 31 based on the control input sensors to optimize the reaction conditions. The chemical reaction monitor ensures the chemical reaction process proceeds safely to generate hydrogen to be released into the internal collection chamber 54 based on the reaction pressure monitor unit. If any sensor in the reaction chamber 31 or collection chamber 54 detects an abnormal event, such as excess rise in temperature or pressure, the reactor heat monitor sensor relays the information to the controller 80 with manual override to shut down the reaction process and enables the reaction to be safely stopped. The reaction chamber 31 can then undergo a complete maintenance and cleanup before the next reaction process. During a normal reaction process, the pressure sensors within the chemical reactor assembly 30 will detect the optimal reaction level and the chemical reaction sensors shown in FIG. 4 will monitor the chemical reaction process. The pressure sensor monitors the pressure built up in the reaction chamber 31 and then safely releases the hydrogen into the collection chamber 54 through one-way valved outlet 32 while the sensors monitor for leaks and update the input control panel with manual override for appropriate action if a leak is detected. Based on the viscosity sensors located in the reaction chamber 31, the controller 80 directs flushing out of chemical reaction metal hydroxide by-product from chamber 31 into the collection tank 41 by opening valved outlet 33.

The chemical reaction in the reaction chamber is an exothermic reaction of metal, e.g., aluminum, and water, resulting in hydrogen (the main product) and metal hydroxide, e.g., aluminum hydroxide, by-product. The heat exchange assembly transfers heat from the reaction chamber 31 into the collection chamber 54 which heat energy is used to compress the hydrogen gas released from the reaction chamber 31 through the one-way valved outlet 32. The hydrogen is compressed using a compressor 55 and the heat transferred through the heat exchange assembly 60. The hydrogen is compressed and stored until the maximum level is reached within the collection chamber 54 or the until a manual override takes place. During a manual override, the hydrogen is safely released into the environment without causing environmental damage. Based on the sensor inputs in the hydrogen collection assembly 50, the hydrogen can be transferred from chamber 54 and released into an external storage container 200.

The by-product from the chemical reaction, aluminum hydroxide, is collected in the collection tank 41 and can be transported to either an aluminum recycling facility, e.g., to convert the aluminum hydroxide back into metallic aluminum, or to other facilities where the aluminum hydroxide is providing as a cost-effective source of material for the fire retardant, agricultural and/or pharmaceutical industries.

The hydrogen that is released into the container 200 is monitored through the sensors for any leaks or any malfunction of the system. The input from the sensors is received by the input control panel with manual override to disconnect the hydrogen transfer and identify the source of the leak or any malfunction.

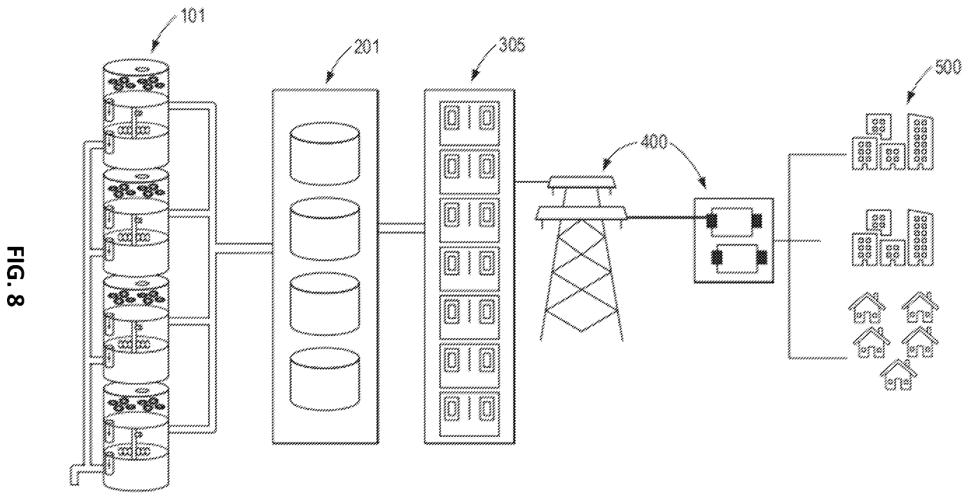

The hydrogen that is stored in the external container 200 can be sent to a fuel cell as shown in FIGS. 2 and 7, or the outputs from a plurality of apparatuses 100 can be combined as shown in FIGS. 7 and 8. Referring specifically to FIG. 8, there is shown a group 101 of apparatuses 100 wherein each apparatus has its hydrogen and by-product outputs combined with one another. The combined hydrogen outputs transfer the hydrogen that is generated in the plurality of apparatuses 100 to a hydrogen storage complex 201, comprised of multiple containers 200. From complex 201, the hydrogen is conveyed to a power generating facility 305 comprising a plurality of fuel cells 300. The operation of the facility 305 can transmit electricity generated by the plurality of fuel cells into an electrical power grid 400 to power a small or big campus or community 500, as shown in FIG. 8. Those skilled in the art will appreciate that the apparatus 100 can be scaled using multiple units in this manner.

The entire operation of apparatus 100 can be continuously monitored by controller 80, e.g., for safety and leaks, through the system control, sensors, safety and monitor block as shown in FIGS. 3, 4, 5 and 6. Based on the inputs from the sensors within each section of the apparatus 100, input safety shut off can be deployed to completely shut down the system safely to maintain and clean up the apparatus. The input weight monitor unit can be deployed to measure the weight of the input material (e.g., aluminum cans) to process the container deposit redemption to be redeemed into depositors' accounts. The input regulator controller controls the inputs and flow of materials through each unit and each chamber to ensure safety of the system. The output regulator controller can monitor the sensor output from each unit within the apparatus 100 and can also monitor the output of each of the internal assemblies. The unit is deployed when there is a manual override of the system or when the system completes a reaction cycle to safely dispose of the by-product to safely control the release of hydrogen into the collection chamber 54 and/or to the external storage container 200. A reaction temperature monitor monitors the temperature in the reaction chamber 31 to not exceed a specific limit and sensors relay the information to the controller 80 to take appropriate actions in case of emergency. One or more hydrogen and/or pressure sensors are deployed within the assembly 50, the container 200 and or in the conduits connecting them to ensure safety of the system from leaks and build-up of pressure within the storage units. The reactor pressure monitor unit sensor monitors the pressure built up in the reaction chamber 31 during the water-metal reaction to release hydrogen into the internal storage chamber and the pressure sensors in the collection chamber 54 monitor the compressed hydrogen pressure to be released into the external storage container 200. The system controller 80 monitors the entire apparatus 100 internal sensors to shut down when an unforeseen event or malfunction of the system occurs. The remote monitoring unit receives inputs from the internal sensors of the apparatus 100 and enables personnel to monitor the system for safety and proper function of the system. The fuel cell monitor monitors the hydrogen release to the fuel cells to maintain optimum hydrogen release and the proper functioning of the fuel cells. The output electricity monitor monitors the electricity generated by the fuel cells or the microgrid and ensures it is safely dispatched to end users.

An analysis of capital costs, generation costs, storage costs, feasibility and flexibility of the apparatus is shown in comparison with solar and natural gas alternatives in the following Table 1, demonstrating that apparatus 100 is a financially attractive alternative to solar power and natural gas from both a clean energy and a zero carbon footprint perspective.

TABLE 1

| 100 KWh | | Natural Gas/ | Apparatus 100 with |
|---|---|---|---|
| (peak energy) | Solar | Fuel Cell | Hydrogen Grid |
| Capital Cost | $300,000 | $400,000 | $400,000 |
| Generation Cost | $0 | $0.10/KWh* | $0.04/KWh** |
| CO2 Emission | $0 | 35 Kg per hour | $0 |
| Potential | None | None | 1500 Soda Cans |
| recycling | | | produce 100 KWh |
| Scrap Metal | | | |
| Capital Cost | $40,000 (e.g., | $0 (Natural | $10,000 (Storing |
| for 1 Backup | PowerWall) | Gas supply) | up to 30 kg of H2) |
| (1 MWh) | | | |
| Geographic | Limited | Versatile | Versatile |
| Conditions and | | | |
| Feasibility | | | |

*Cost of burning natural gas
**Assuming the cost of aluminum scrap metal

Disclosed herein is a solution for zero waste energy by recycling on the edge. The present disclosure comprises a scalable and accessible recycling system, which reduces carbon emissions, provides efficient energy generation and storage, and recycles metal, such as aluminum.

The method and apparatus disclosed herein recycles metal (e.g., aluminum), generates hydrogen and either (i) stores hydrogen near the end-user, with the ability to convert to electricity on demand, or (ii) is connected to a hydrogen conveyance mechanism (e.g., pumps and pipe lines) for conveying the hydrogen to a central depot. The apparatus allows the user to recycle aluminum and generate energy in the form of hydrogen, an efficient way of storing energy. With the recent development of fuel cell-powered electric automobiles, which fuel cells generate electricity using oxygen from the air and on-board compressed hydrogen in order to power the on-board electric motor, safe ways to store and transport hydrogen have been established. The present apparatus can be used at an edge location such as a single-family residence, a multiunit residential building (e.g., an apartment complex) a commercial office campus, school or the like. The present apparatus can be scaled to be used at a small regional level such as a large university campus, a city, county, or a small state. The wider scale uses of the present apparatus can be accomplished by using a grid to combine the hydrogen generated at multiple edge locations and conveying it for storage in a central location. The stored hydrogen, whether stored at a single edge location or at a central grid location, can then be used to power machines (e.g., automobiles) that use fuel cell technology. Thus, the present apparatus not only recycles metal such as aluminum in an energy-efficient way, but also provides an alternative clean energy solution to store hydrogen and generate electricity.

The present apparatus and method is utilized to create, store, and optionally distribute hydrogen for clean energy generation. The apparatus combines a soft metal with water in a reaction chamber. In one embodiment the soft metal is aluminum in recyclable form such as emptied and recyclable aluminum or steel-based food and beverage cans. The apparatus subjects the metal to a chemical reaction with water to produce hydrogen. The hydrogen gas generated in the reaction chamber is pumped out as it is generated, and can be stored in a separate pressure vessel or pumped and conveyed through a grid to a centralized hydrogen storage location. Once stored the hydrogen can be converted to electricity using one or more fuel cells via conventional known means.

The apparatus feeds the cut, shredded and/or ground soft metal in a controlled manner into a reaction chamber where hydrogen is generated through a chemical reaction. The hydrogen generated in the reaction chamber is collected and stored as an energy source. This hydrogen can be used to generate electricity on demand using fuel cells or can also be sent to a central grid for storage and power generation.

A metal hydroxide is also generated as a by-product of the hydrogen generating chemical reaction. When a mix of recycled metal containers is used as the source of soft metal, a mix of metal hydroxides are produced as by-products, e.g., aluminum hydroxide, iron hydroxide and tin hydroxide. When aluminum is used as the soft metal, aluminum hydroxide is the by-product that is generated. Aluminum hydroxide can either be recycled back to aluminum through the process of electrolysis, or can also be collected and used in applications such as polymer flame retardants, in pharmaceutical products such as antacids and/or in crop protection products.

In one embodiment, the apparatus and method are designed based on a chemical reaction between aluminum metal and water to produce hydrogen and aluminum hydroxide. The basic reaction formula is:

2Al+6H2O→3H2+2Al(OH)3.

On a weight basis, this means that the aluminum and water react in a weight ratio of about 1:2, i.e., 1 weight unit of aluminum to 2 weight units of water. For example, in a reaction of 10 liters (˜2.6 gals), or 10 kg of water, about 5 kg of aluminum are required to run the reaction to theoretical completion. In the case of using recycled aluminum drink cans as the source of aluminum for the reaction, a typical 12-fluid ounce volume aluminum can weighs about 14.9 g. For 10 liters of water, and assuming about 95% of the weight of the aluminum can is aluminum, one would need about 350 cans to achieve a 1:2 weight ratio of aluminum to water. The amount of hydrogen gas produced by such reactant amounts, assuming the reaction goes to completion, would be about 20 moles or 40 g of H2, or using the ideal gas law, about 450 liters of H2 at standard temperature and pressure. This is enough hydrogen to drive a commercial hydrogen powered compact car over 5 km (Honda Clarity, rated at 650 km of range with a 5 kg hydrogen tank).

In addition, the reaction of aluminum with water to produce hydrogen is exothermic as shown in Table 2, which means that heat is generated during the reaction.

TABLE 2

| Temperature | ΔH | ΔS | ΔG |
|---|---|---|---|
| (° C.) | (kJ/mol H2) | (J/K) | (kJ/mol H2) |
| 0 | −277 | 26.2 | −284 |
| 100 | −284 | 3.29 | −285 |
| 200 | −291 | −12.1 | −285 |

The apparatus and method disclosed herein takes advantage of this heat generation by using a heat exchanger to draw heat out of the reaction chamber and use it as an energy source to compress the generated hydrogen gas.

The speed at which the aluminum and water reaction proceeds can be increased by raising the pH of the reaction mixture above about 8, and particularly above about pH 10. This can be achieved by adding sodium hydroxide to the reaction mixture. A typical catalytic amount of sodium hydroxide in the reaction mixture is about 0.1 wt %. For a reaction containing 10 liters (i.e., 10 kg) of water, one would add about 1 kg of lye to achieve the 0.1 wt % level. Other reaction promoters such as aluminum oxide (Al2O3) can be added to catalyze the aluminum-water reaction. However, the reaction can be run at lower speeds using near neutral pH levels. Aluminum in particle form, including some level of aluminum oxide which will typically be present on any recycled aluminum material, will react with water in the pH range of about 4-9 and at a temperature in the range of about 10 to 90° C., which is easily within the capabilities of non-laboratory point of recycling, i.e., edge locations.

The use of hydrogen to generate energy is advantageous because of the salient features of this gas. Hydrogen has a high calorific power (hydrogen has a higher heating value, or HHV, equal to 141.9 MJ/kg and a lower heating value, or LHV equal to 19.9 MJ/kg) that is approximately 2.5 times that of gasoline. Burning hydrogen in the presence of air or pure oxygen is completely clean with the concomitant formation of water and no carbon dioxide.

In certain embodiments, the reaction chamber can maintain an optimal pH level of the reaction mixture. The reaction chamber can utilize one or more pH sensors which provide feedback to the valve controlling the inlet of water into the reaction chamber or the outlet of by-product from the reaction chamber. In another embodiment, the reaction chamber deploys a pressure sensing and feedback mechanism to operate the one-way valve between the reaction chamber and hydrogen collection chamber. As the hydrogen is produced, it increases the pressure in the reaction chamber. The pressure sensors control this valve to periodically release the generated hydrogen gas into the collection chamber. In another embodiment, the reaction chamber utilizes a temperature sensor and heat transmitting walls to exchange heat generated by the exothermic reaction occurring in the reaction chamber and provide that heat energy to the hydrogen collection assembly to use as an energy source to compress the collected hydrogen gas.

### EMBODIMENTS

Embodiment 1. An apparatus (also called a Smartbin™) which accepts recyclable soft metal sources substantially consisting of aluminum or other soft metal as input, performs the conversion of soft metal to hydrogen using a controlled chemical reaction of the input soft metal with water, storage of hydrogen with potential conversion to on-demand electricity using a fuel cell or transmission of hydrogen or electricity to a grid. The apparatus is substantially comprised of: an input aperture for providing input recyclable soft metal, a pre-reactor chamber for processing of the input metal to a suitable form for chemical reaction and controlling the delivery of the input to the next stage; further connected to a reactor chamber designed to efficiently enable the chemical reaction with water to produce hydrogen and byproduct, and to regulate and dissipate the heat generated in the aforesaid chemical reaction; further connected to a hydrogen outflux section to an output chamber to store hydrogen locally, convert to electricity on-demand or transmit the locally generated hydrogen or electricity to a grid; containing a post-reaction byproduct processing capability to remove the byproduct of the chemical reaction; containing an integrated safety and operations controller subsystem to monitor the flow of materials and various components in the system.

Embodiment 2. The apparatus of embodiment 1, further comprising an input aperture to feed in recyclable soft metal.

Embodiment 3. The apparatus of embodiment 2, where the input metal is in the form of aluminum cans, foils or shavings or other forms of aluminum of any size.

Embodiment 4. The apparatus of embodiment 2, where the input metal is any soft metal which can combine in a chemical reaction with water to produce hydrogen.

Embodiment 5. The apparatus of embodiment 2, further comprising an electronic or mechanical or electro-mechanical separation mechanism designed to filter and separate metal particles from non-metal particles.

Embodiment 6. The apparatus of embodiment 2, further comprising a pulverisation or shredding mechanism designed to convert the separated input metal into a form suitable for later processing.

Embodiment 7. The apparatus of embodiment 2, further comprising a sensor system designed to monitor the size or weight of input metal particles to achieve optimal reaction parameters such as time and temperature of the future chemical reaction.

Embodiment 8. The apparatus of embodiment 8, further incorporating feedback from the reaction chamber to control the input and pulverization mechanism to regulate the size, amount and/or rate of addition of input particles.

Embodiment 9. The apparatus of embodiment 8, releasing a controlled amount of metal particles into the downstream reaction chamber and sub-chambers to regulate and control the reaction parameters.

Embodiment 10. The apparatus of embodiment 8, further incorporating feedback from sensors in the reaction chamber to regulate the release of controlled amounts of metal particles into the reaction chamber.

Embodiment 11. The apparatus of embodiment 2, further comprising a mechanism to redeem a container deposit redemption by the user in the form or a credit applied to the user.

Embodiment 12. The apparatus of embodiment 11, wherein the credit applied to the user is a CRV (California Redemption Value) credit provided to the customer in the form a deposit into a customer card.

Embodiment 13. The apparatus of embodiment 11, wherein the credit applied to the user is a container deposit redemption credit in the form of deposit into a mobile application.

Embodiment 14. The apparatus of embodiment 11, wherein the credit applied to the user is in the form of points and/or a monetary incentive system in paper or electronic form.

Embodiment 15. The apparatus of embodiment 1, further comprising a series of chambers which create a controlled chemical reaction process of the metal provided by the input aperture referenced in embodiment 1 with water to release hydrogen gas.

Embodiment 16. The apparatus of embodiment 15, further comprising a reactor chamber with one or more sub-chambers designed to intake the processed metal particles and water along from the pre-reactor without releasing the generated hydrogen gas.

Embodiment 17. The apparatus of embodiment 16, where the input intake chute deposits the input metal particles directly below the surface of the water in the reaction container.

Embodiment 18. The apparatus of embodiment 16, where the input intake chute deposits the input metal particles above the surface of the water in the reaction container.

Embodiment 19. The apparatus of embodiment 16, where there is one sub-chamber in the reactor chamber.

Embodiment 20. The apparatus of embodiment 16, where there are more than one sub-chambers in the reactor chamber, for the purposes of containing and alternating the reaction and evacuation of the by-product of the reaction.

Embodiment 21. The apparatus of embodiment 15, further maintaining optimal parameters of the chemical reaction such as temperature and pressure within the chamber to optimize the chemical reaction.

Embodiment 22. The apparatus of embodiment 15, further designed to allow the generated hydrogen to build up the optimal positive pressure to allow an easy release out of the reaction chamber into the storage chamber.

Embodiment 23. The apparatus of embodiment 15, further including a sensor to monitor the concentration of the aluminum hydroxide and any other catalyst to optimize the reaction process.

Embodiment 24. The apparatus of embodiment 15, further providing a mechanism for release of aluminum hydroxide solution from the reaction chamber into a collector for recycling.

Embodiment 25. The apparatus of embodiment 24, allowing the manual flush and replace of the entire non-hydrogen content by drawing from the bottom of the cylinder.

Embodiment 26. The apparatus of embodiment 15, further consisting of a mechanism to remove the hydrogen from the reactor chamber in a controlled manner.

Embodiment 27. The apparatus of embodiment 26, using a pipe from the top of the chamber with a one-way valve to remove hydrogen from the reactor chamber in a controlled manner.

Embodiment 28. The apparatus of embodiment 26, using a compression mechanism to further compress the hydrogen gas in the reactor and pump it out of the egress pipe due to differential pressure.

Embodiment 29. The apparatus of embodiment 26, allowing the connection of third party hydrogen conversion or compression mechanisms to remove the hydrogen from the reactor chamber.

Embodiment 30. The apparatus of embodiment 15, further providing a mechanism for dissipation and regulation of heat from the chemical reaction.

Embodiment 31. The apparatus of embodiment 1, comprising an output block to store the hydrogen output from the reactor chamber.

Embodiment 32. The apparatus of embodiment 31, further being able to send hydrogen to a local fuel cell to be converted to electricity.

Embodiment 33. The apparatus of embodiment 31, using the output egress pipe to send hydrogen to an attached commercial fuel cell battery.

Embodiment 34. The apparatus of embodiment 31, using the output egress pipe to partially send hydrogen to an attached commercial fuel cell battery.

Embodiment 35. The apparatus of embodiment 31, able to send hydrogen gas to external storage or central hydrogen grid for storage.

Embodiment 36. The apparatus of embodiment 1, having an integrated safety apparatus to control, monitor, shut down and manage the flow of material and state of various components of the system.

Embodiment 37. The apparatus of embodiment 36, further consisting of a backup power source to maintain safety monitoring in the event of a power shutdown.

Embodiment 38. The apparatus of embodiment 36, further consisting of a manually operated emergency shut-off mechanism with capabilities of local or remote control with a wireline or wireless internet connectivity.

Embodiment 39. The apparatus of embodiment 36, further comprising a shutdown system to terminate the input, chemical and output operation of the system and bring to a safety state in the event of complete power loss.

Embodiment 40. The apparatus of embodiment 36, including means for running diagnostics on startup, reset and at frequent intervals to monitor the health of the system and schedule preventative maintenance.

Embodiment 41. The apparatus of embodiment 36, including means to maintain the hydrogen pressure in the hydrogen storage container under a safety threshold level and safely discharge the hydrogen if needed.

Embodiment 42. The apparatus of embodiment 36, including means to monitor temperature inside the reaction chambers and safely reset the reaction above a monitored threshold.

Embodiment 43. The apparatus of embodiment 36, including means to monitor the input chamber quality and flow of materials.

Embodiment 44. The apparatus of embodiment 43, further detecting the parameters of the input metal including density and to detect any contaminants and stop operation in the event of hazardous contaminants.

Embodiment 45. The apparatus of embodiment 43, safely discarding any contaminants into a receptacle.

Embodiment 46. The apparatus of embodiment 43, monitoring the shredder operation through sensor feedback such as on vibrations, speed and sound.

Embodiment 47. The apparatus of embodiment 36, monitoring the collector chamber for safety operation including hazardous material presence, sudden temperature rise, and waste build-up.

Embodiment 48. The apparatus of embodiment 36, monitoring the reaction and storage chambers using sensors for abnormal parameters including pressure, temperature, gas flow and gas concentration.

Embodiment 49. The apparatus of embodiment 36, monitoring any pipes connecting to a hydrogen grid for leakage and pressure drops.

Embodiment 50. The apparatus of embodiment 36, monitoring any locally connected fuel cells to stay within safety and operational parameters.

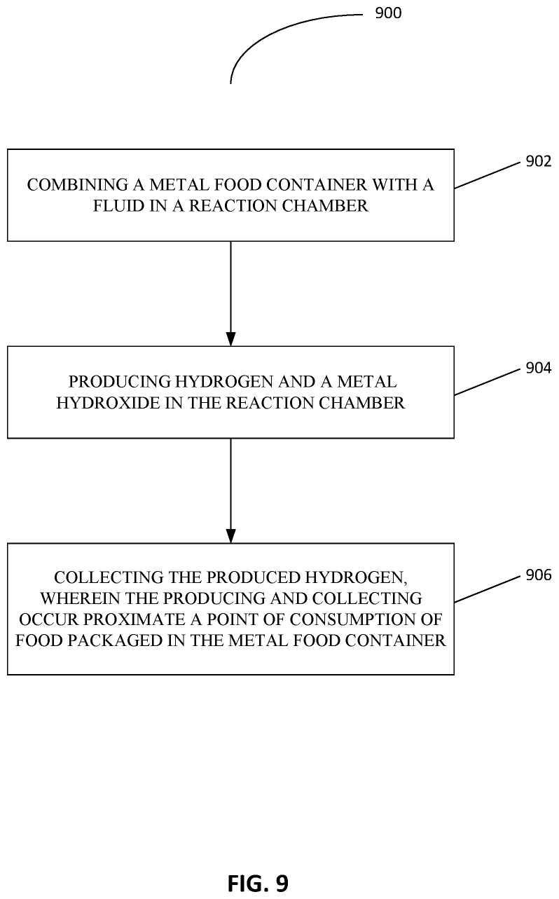

FIG. 9 is a flow diagram illustrating a method in accordance with an aspect of the present disclosure.

A method 900 in accordance with an aspect of the present disclosure may generate hydrogen. Method 900 includes block 902, which illustrates combining a metal food container with a fluid in a reaction chamber. Method 900 also includes block 904, which illustrates producing hydrogen and a metal hydroxide in the reaction chamber. Method 900 also includes block 906, which illustrates collecting the produced hydrogen, wherein the producing and collecting occur proximate a point of consumption of food packaged in the metal food container.

The embodiments described herein are not intended to be exhaustive or to limit the disclosure to the precise forms disclosed. As such, many modifications and variations will be apparent. Accordingly, it is intended that the scope of the disclosure be defined by the following claims and their equivalents.

What is claimed is:

1. A method of generating hydrogen, comprising:
combining a metal food container with a fluid in a reaction chamber;
producing hydrogen and a metal hydroxide in the reaction chamber; and
collecting the produced hydrogen; wherein the producing and collecting occur proximate a point of consumption of food packaged in the metal food container.

2. The method of claim 1, further comprising splitting the metal food container into a plurality of pieces prior to combining the metal food container with the fluid in the reaction chamber.

3. The method of claim 2, wherein a size of the plurality of pieces of the metal food container comprises an average volume of less than 100 mm³.

4. The method of claim 1, wherein the metal food container is powderized prior to combining the metal food container with the fluid in the reaction chamber.

5. The method of claim 1, further comprising collecting the metal hydroxide.

6. The method of claim 1, further comprising pressurizing the collected produced hydrogen.

7. The method of claim 1, further comprising collecting heat generated at the reaction chamber.

8. The method of claim 1, further comprising producing electricity from the collected produced hydrogen.

9. The method of claim 1, wherein the metal food container comprises at least one of aluminum, tin-plated steel, an aluminum alloy, and a tin-plated steel alloy.

10. The method of claim 1, wherein the metal food container comprises aluminum, the reaction comprises 2Al+6H2O→2Al(OH)3+3H2, and the metal hydroxide is aluminum hydroxide.

11. An apparatus for generating hydrogen, comprising:
an inlet for receiving at least one metal container;
a water inlet;
a reaction chamber, coupled to the inlet and the water inlet, the reaction chamber having at least a hydrogen outlet and a by-product outlet; and
a collection chamber for receiving hydrogen from the reaction chamber through the hydrogen outlet;
wherein the apparatus comprises a size and a weight such that the apparatus is installable at a location proximate a point of consumption of food packaged in the at least one metal food container.

12. The apparatus of claim 11, further comprising a grinder, coupled between the inlet and the reaction chamber, for separating the at least at least one metal container into a plurality of pieces.

13. The apparatus of claim 12, wherein the grinder separates the at least one metal container into the plurality of pieces wherein each piece in the plurality of pieces has an average volume of less than 100 mm³.

14. The apparatus of claim 13, wherein the grinder powderizes the at least one metal container.

15. The apparatus of claim 11, further comprising a by-product collection chamber coupled to the by-product outlet of the reaction chamber for conveying the metal hydroxide out of the reaction chamber.

16. The apparatus of claim 11, further comprising means for pressurizing the collected hydrogen.

17. The apparatus of claim 11, wherein the apparatus is configured to process at least one of aluminum, tin-plated steel, an aluminum alloy, and a tin-plated steel alloy.

18. The apparatus of claim 11, further comprising a heat exchanger, coupled to the reaction chamber, for gathering heat generated in the reaction chamber.

19. The apparatus of claim 16, the apparatus having a size of less than 5 m³.

20. An apparatus for generating electricity, comprising:
a plurality of collector apparatuses, each collector apparatus in the plurality of collector apparatuses comprising:
an inlet for receiving at least one metal container;
a reaction chamber, coupled to the inlet, the reaction chamber having at least a hydrogen outlet and a by-product outlet; and
a collection chamber for receiving hydrogen from the reaction chamber through the hydrogen outlet;
a conveying pipeline for coupling the hydrogen outlets from the plurality of collector apparatuses to a centralized collector; and
a cell, coupled to the centralized collector and adapted to convert the hydrogen in the centralized collector into electricity.
